(19) United States
(12) Patent Application Publication
(10) Pub. No.: US 2025/0303476 A1
(43) Pub. Date: Oct. 2, 2025

(54) EXPANDABLE JAM CHUCK AND KIT

(71) Applicant: Dan Tyroler, Great Neck, NY (US)

(72) Inventor: Dan Tyroler, Great Neck, NY (US)

(21) Appl. No.: 19/093,630

(22) Filed: Mar. 28, 2025

Related U.S. Application Data
(60) Provisional application No. 63/572,622, filed on Apr. 1, 2024.

(51) Int. Cl. B23B 31/40

(52) U.S. Cl. CPC B23B 31/4013

(57) ABSTRACT

The present disclosure pertains to an expandable jam chuck and a kit to address a need for a versatile and efficient tool in woodturning. The expandable jam chuck includes a base jam chuck configured to mechanically connect individually or along with one or more expansion jam chucks, with a lathe chuck or coupled and mounted onto the threaded shaft of the lathe. An intermediate expansion jam chuck interlocks with the base jam chuck, while additional expansion jam chucks interlock in a nested arrangement over the intermediate jam chuck. The expandable jam chuck allows selective interlocking based on the internal surface profile and size of a workpiece.

### TECHNICAL FIELD

The present disclosure relates to woodworking lathe tools, specifically to an expandable jam chuck used in woodturning for securely holding and shaping various sizes of wooden workpieces on a lathe.

### BACKGROUND

In the field of woodworking, particularly in woodturning, a significant need exists for versatile and efficient tools. Woodturners often require chucks and jam chucks to securely hold and shape various sizes of wooden workpieces on a lathe. A jam chuck is an essential tool used by wood bowl turners to craft, refine, remove, and shape any accessible section of the workpiece, such as the tenon or foot of a bowl or any other. A jam chuck can also be used for any other projects that include a curved empty hollow section in the work piece that the jam chuck can be inserted into, in order to work on that piece. Often made as a one-off single-purpose unit, a jam chuck mounts in the lathe headstock and provides a friction-fit cavity or surface that the turning can “jam” against. Tailstock of the lathe is usually brought into play at the same time to press the workpiece against the jam chuck.

Other solutions include use of self-made “dummy” jam chuck/mandrel in order to hold the workpiece being processed. Such custom-made jam chucks are typically designed for single-use or specific projects, which may be costly, time-consuming, and inefficient. Custom-made jam chucks often lack the flexibility to accommodate other workpieces having different sizes and shapes, necessitating the creation of multiple custom jam chucks for different projects. Additionally, commercially available options, such as vacuum systems and large gripping devices, may be expensive and may not be compatible with existing equipment, further complicating and increasing the cost of the woodturning process.

Existing jam chucks used in woodturning are also often limited in adaptability and can be cumbersome to use. Many jam chucks are designed for metalworking and do not adequately address the specific needs of woodturners, such as fitting curved shapes or providing a non-marring grip. Furthermore, some solutions require disassembly and reassembly of components, which can interrupt workflow and reduce efficiency.

Also, another common jam chuck/mandrel that is used by woodturners is a faceplate that is mounted on the chuck, which has adjustable holding pins that can grab the outer side of the piece to work on. Such tools can be handy if there are no inner holes that a curved mandrel is inserted into. A major drawback of such solutions is that it prevents the woodturner from completing the work in the area the grabbing pins/wheels are present. The other disadvantage is that such solutions force the woodturner to assemble and disassemble parts from the chuck, dedicating the chuck for such tool.

Therefore, it is desired to overcome the drawbacks, shortcomings, and limitations associated with existing solutions, and develop a jam chuck that is versatile, cost-effective, and capable of securely holding various sizes and shapes of wooden workpieces on a lathe.

### SUMMARY

Aspect of the present disclosure relates to woodworking lathe-working tools, specifically to an expandable jam chuck used in woodturning for securely holding and shaping various sizes of wooden workpieces on a lathe.

An aspect of the present disclosure relates to an expandable jam chuck mounting a wooden workpiece on a lathe, the wooden workpiece having a concave end opening defined by an internal surface, said expandable jam chuck including: a base jam chuck having a base jam chuck end configured for securing said base jam chuck to the lathe, and a portion formed with a base outer surface, and an expansion jam chuck having an interlocking member coupling the expansion jam chuck to the base jam chuck and having an expansion outer surface, where one of the base outer surface and the expansion outer surface are shaped and sized to form a frictional engagement with the internal surface of the wooden workpiece to prevent rotation between the respective base jam chuck and the expansion jam chuck. This allows for workpieces of various sizes and shapes to be easily and securely mounted on a lathe, expanding the range of projects that can be undertaken.

In one or more embodiments, the lathe may include a motor and the base jam chuck end may be coupled to the motor to rotate the wooden workpiece.

In one or more embodiments, the lathe may have a chuck and the base jam chuck end may be coupled to the chuck.

In one or more embodiments, the lathe may have a main threaded shaft and the base jam chuck end may be coupled to the main threaded shaft.

In one or more embodiments, the base jam chuck may include at least one of a tenon, a shoulder, or a provision, configured to mechanically connect the base jam chuck with a chuck of the lathe and/or a headstock of the lathe or the base jam chuck with a main threaded shaft of the lathe.

In one or more embodiments, the interlocking member may include one or more channels on the base outer surface, the one or more channels being configured to mechanically couple with one or more interlocking ribs on an expansion inner side of the expansion jam chuck.

In one or more embodiments, the expandable jam chuck may further include a successive expansion jam chuck configured to mount over the expansion jam chuck and/or another successive jam chuck mounted over the expansion jam chuck.

In one or more embodiments, a diameter of the successive jam chuck is greater than that of the expansion jam chuck and/or the another successive expansion jam chuck.

In one or more embodiments, one or more interlocking ribs defined on an expansion inner surface of the successive expansion jam chuck are configured to mechanically couple with one or more channels defined on the expansion outer surface or an outer surface of the another successive expansion jam chuck.

In one or more embodiments, the expansion jam chucks may include a recess configured to enable the expansion jam chucks to be removed from the base jam chuck when a levered element is pushed into the recess to separate the one or more interlocking ribs from the one or more channels.

In one or more embodiments, the base jam chuck and the expansion jam chuck may include materials made of any one or a combination of plastics and metals.

In one or more embodiments, the base jam chuck and the expansion jam chuck may be made of different materials.

In one or more embodiments, the expansion jam chuck and/or one or more successive jam chucks mounted over the expansion jam chuck may include a supporting rib defined on an inner surface thereof.

In one or more embodiments, a cloth material may be disposed between the expansion jam chuck and the base jam chuck, and/or between the expansion jam chuck and one or more successive jam chucks mounted over the expansion jam chuck to prevent sliding therebetween.

In one or more embodiments, the workpiece may be secured between the expandable jam chuck and a tailstock of the lathe.

An aspect of the present disclosure relates to an expandable jam chuck, including a base jam chuck configured to mechanically connect with a chuck of a lathe or mounted directly onto a threaded shaft of the lathe, and one or more expansion jam chucks, where an intermediate expansion jam chuck from the one or more expansion jam chucks is configured to interlock with the base jam chuck, and other expansion jam chucks from the one or more expansion jam chucks are configured to interlock in a nested arrangement over the intermediate expansion jam chuck, where each of the one or more expansion jam chucks is selectively interlocked in the nested arrangement based on an internal surface profile and size of a workpiece.

In one or more embodiments, the base jam chuck and the one or more expansion jam chucks may be assembled to form an expandable jam chuck, which has a geometric profile indicative of any one or a combination of a hemispherical profile, a conical profile, a cylindrical profile, an oval profile, or an irregular profile, and where the one or more expansion jam chucks may include one or more recesses to facilitate disassembly.

In one or more embodiments, the base jam chuck and the one or more expansion jam chucks may be assembled to form an expandable jam chuck, which has a geometric profile indicative of any one or a combination of a substantially frusto-hemispherical profile, a substantially frusto-conical profile, a substantially frusto-hemiovoidal profile, a substantially frusto-prismatic profile, an irregular profile, or a substantially frusto-oval profile.

In one or more embodiments, the base jam chuck and/or the one or more expansion jam chucks may include lips on an outer and bottom side of the base jam chuck and/or the other expansion jam chucks thereof for assembly, to stop and prevent any of the one or more expansion jam chucks from rolling to the side, and keeping all used expansion jam chucks aligned vertically.

In one or more embodiments, a geometric profile of an expandable jam chuck formed by the base jam chuck, or the base jam chuck and the one or more expansion jam chucks may partially or entirely complement the internal surface profile of the workpiece.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1A illustrates an exemplary representation of a lathe or a woodturning/woodworking apparatus for woodworking, having an expandable jam chuck connected to a chuck of the lathe, in accordance with an embodiment of the present disclosure.

FIG. 1B illustrates an exemplary representation of the workpiece held by the expandable jam chuck and the tail stock, in accordance with an embodiment of the present disclosure.

FIG. 1C illustrates an exemplary representation of a longitudinal cross-section view of a workpiece mounted between the expandable jam chuck and a tailstock of a lathe assembly for woodworking, in accordance with an embodiment of the present disclosure.

FIG. 1D illustrates an exemplary representation of the lathe or the woodturning/woodworking apparatus for woodworking, having the expandable jam chuck directly connected to the lathe, in accordance with an embodiment of the present disclosure.

FIG. 2 illustrates an exemplary representation of a bottom view of a base jam chuck, in accordance with an embodiment of the present disclosure.

FIG. 3 illustrates an exemplary representation of a top view of the base jam chuck, in accordance with an embodiment of the present disclosure.

FIG. 4 illustrates an exemplary representation of a side view of the base jam chuck, in accordance with an embodiment of the present disclosure.

FIG. 5 illustrates an exemplary representation of a perspective view of the base jam chuck, in accordance with an embodiment of the present disclosure.

FIG. 6 illustrates an exemplary representation of another side view (horizontally positioned) of the base jam chuck, in accordance with an embodiment of the present disclosure.

FIG. 7 illustrates an exemplary representation of a bottom view of an expansion jam chuck, in accordance with an embodiment of the present disclosure.

FIG. 8 illustrates an exemplary representation of a top view of the expansion jam chuck, in accordance with an embodiment of the present disclosure.

FIG. 9 illustrates an exemplary representation of a vertically positioned side view of the expansion jam chuck, in accordance with an embodiment of the present disclosure.

FIG. 10 illustrates an exemplary representation of a perspective view of the expansion jam chuck, in accordance with an embodiment of the present disclosure.

FIG. 11 illustrates an exemplary representation of a horizontal positioned side view of the expansion jam chuck, in accordance with an embodiment of the present disclosure.

FIG. 12 illustrates an exemplary representation of a top view of the intermediate expansion jam chuck interlocked with the base jam chuck, in accordance with an embodiment of the present disclosure.

FIG. 13 illustrates an exemplary representation of an assembled view of the intermediate expansion jam chuck interlocked with the base jam chuck, in accordance with an embodiment of the present disclosure.

FIG. 14 illustrates an exemplary representation of a bottom view of the intermediate expansion jam chuck interlocked with the base jam chuck, in accordance with an embodiment of the present disclosure.

FIG. 15 illustrates an exemplary representation of an exploded/disassembled view of the intermediate jam chuck and the base jam chuck, in accordance with an embodiment of the present disclosure.

FIG. 16 illustrates an exemplary representation of a top view of the expandable jam chuck, in accordance with an embodiment of the present disclosure.

FIG. 17 illustrates an exemplary representation of a vertical side view of the expandable jam chuck, in accordance with an embodiment of the present disclosure.

FIG. 18 illustrates an exemplary representation of a bottom view of the expandable jam chuck, in accordance with an embodiment of the present disclosure.

FIG. 19 illustrates an exemplary representation of a disassembled/exploded view of the expandable jam chuck, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present disclosure addresses the challenges faced by woodturners who require a versatile and efficient tool to securely hold various sizes of wooden workpieces on a lathe for woodworking. Traditional jam chucks are often single-use, lack flexibility, and can be expensive, making them unsuitable for accommodating different workpiece sizes and shapes. The expandable jam chuck and kit of the present disclosure provide a solution by offering a base jam chuck that mechanically connects with a lathe chuck, and one or more expansion jam chucks that interlock over the base jam chuck in a nested arrangement. Such configuration allows for selective interlocking based on size and the internal surface profile of the workpiece, thereby overcoming the limitations of existing solutions. As a result of using the expandable jam chuck, there is strong and secure frictional engagement between an outer surface of the expandable jam chuck and at least a portion of an inner concave wall or inner surface of the workpiece cavity.

The present disclosure improves efficiency and provides versatility through the use of an expandable jam chuck. The interlocking mechanism of the expansion jam chucks provides a secure and stable grip on the workpiece, prevents sliding, and ensures precision during the turning process, for a wide range of internal surface profiles of the workpiece. The ability to adjust the configuration/geometric profile and/or size of the jam chuck based on the workpiece's profile and size allows for a customized fit, reducing the need for multiple custom tools. Additionally, the use of materials, such as plastics or metals, offers a cost-effective solution, making the tool accessible to a wide range of users.

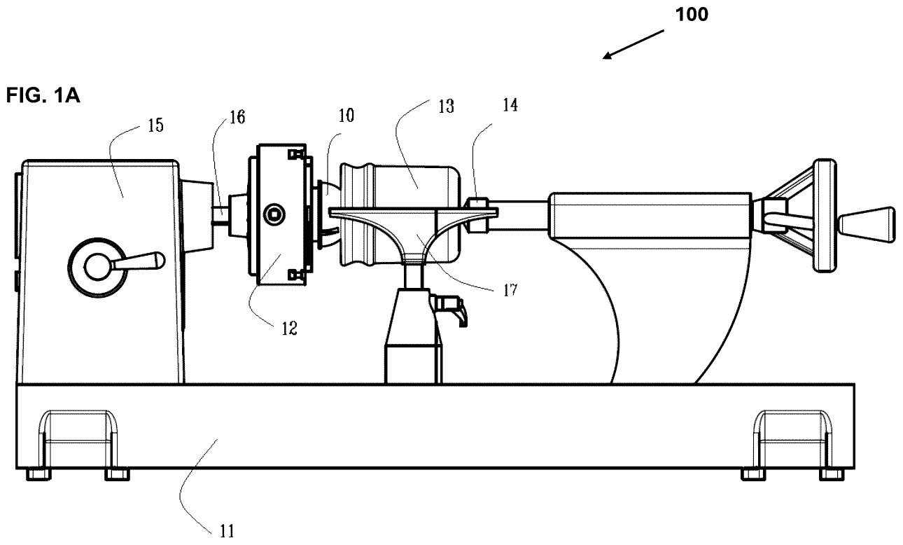

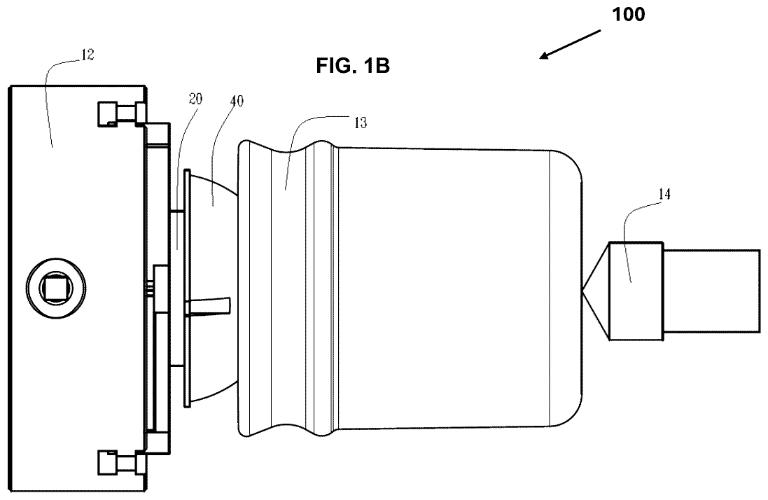

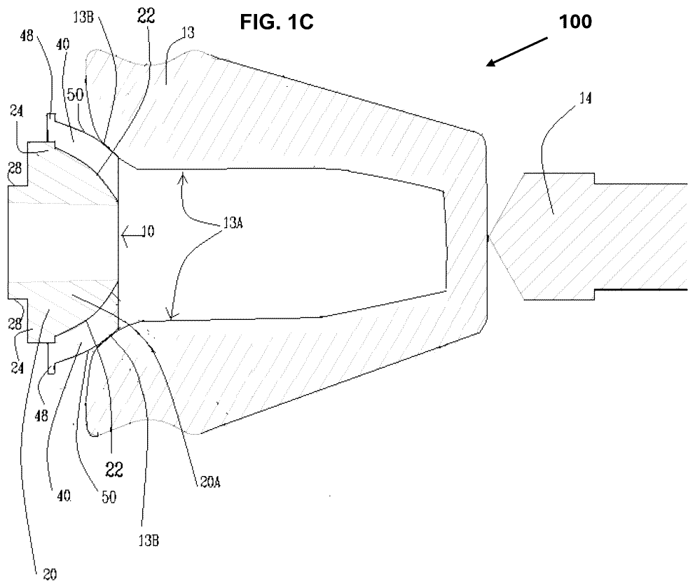

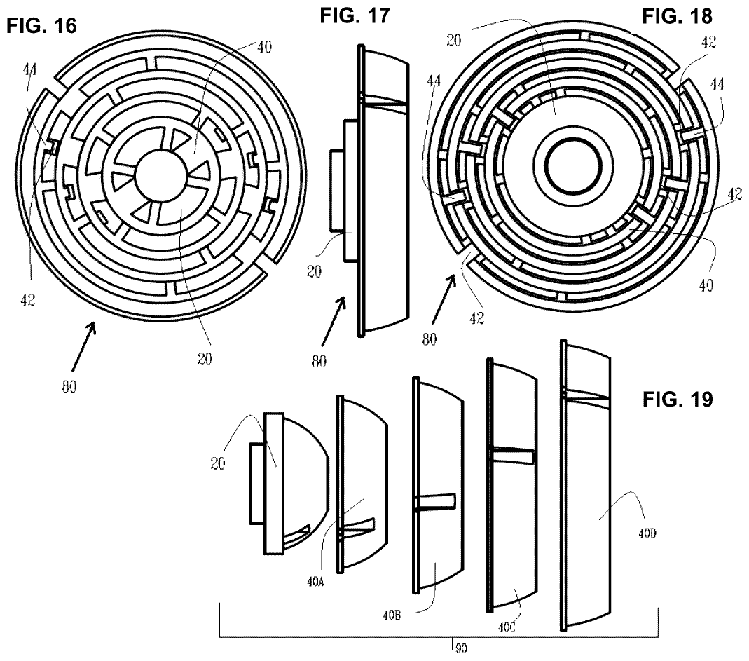

The various embodiments throughout the disclosure will be explained in more detail with reference to FIGS. 1A-19.

Embodiments explained herein relate to woodworking tools, specifically to an expandable jam chuck used in woodturning for securely holding and shaping various sizes of wooden workpieces on a lathe.

Referring now to FIG. 1A and ID, a woodturning/woodworking apparatus 100 for woodworking is illustrated, in accordance with one or more embodiments of the present disclosure. The woodworking apparatus 100 may be configured to facilitate various woodworking operations, particularly involving turning and shaping of a workpiece. The woodworking apparatus 100 may include a lathe (machine) 11, which serves as the primary apparatus for supporting and rotating the workpiece for woodworking. The lathe machine 11 may include a headstock having a chuck/lathe chuck 12, a main threaded shaft 16, and a tailstock 14. The woodworking apparatus 100 may also include a motor or lathe motor assembly 15. The lathe motor assembly 15 may be operably coupled to the lathe chuck 12, and configured to provide the necessary rotational motion to the expandable jam chuck 10 at various adjustable speeds, thereby allowing for different woodturning requirements. The woodworking apparatus 100 may further include a tool rest/tool stand 17 configured to support a tool (such as gouges, chisels, scrapers, sanding tools, and the like, but not limited thereto) for woodworking. The woodworking apparatus 100 may also include an expandable jam chuck 10 configured to support/hold a work piece 13 between the lathe chuck 12 and the tailstock 14.

The lathe chuck 12 is configured to securely hold and rotate the expandable jam chuck 10 during woodturning. Typically, the workpiece 13 may be supported between the tailstock 14 and the lathe chuck 12. For workpieces 13 that have a curved internal surface profile, such as bowls, vessels, pen-making, and the like, a jam chuck may also be placed between the lathe chuck 12 and the workpiece 13, with the workpiece 13 being held by the compression of the jam chuck and the tailstock 14. To prevent the compression from damaging the workpiece 13, and to hold the workpiece 13 securely through friction to prevent sliding during woodworking, it is desirable to define the geometric profile of the jam chuck to be similar to that of the internal surface of the workpiece 13. The jam chuck has to be shaped to fit snugly into the workpiece 13. The workpiece 13 may be “jammed” onto the jam chuck, which holds it in place using friction or a tight fit. However, for the problems stated in the background section of the present disclosure, it is infeasible and expensive to have jam chucks for every possible internal surface profile of the workpiece 13.

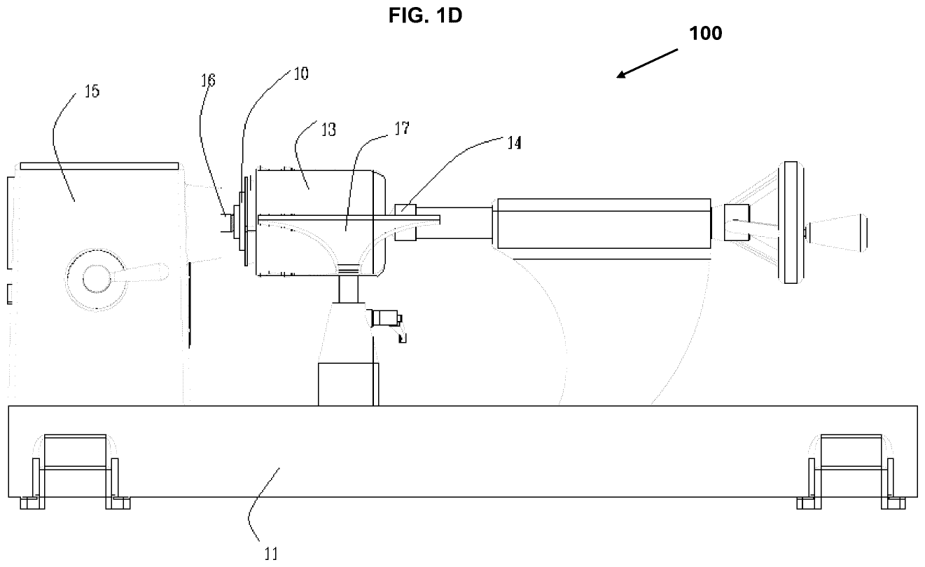

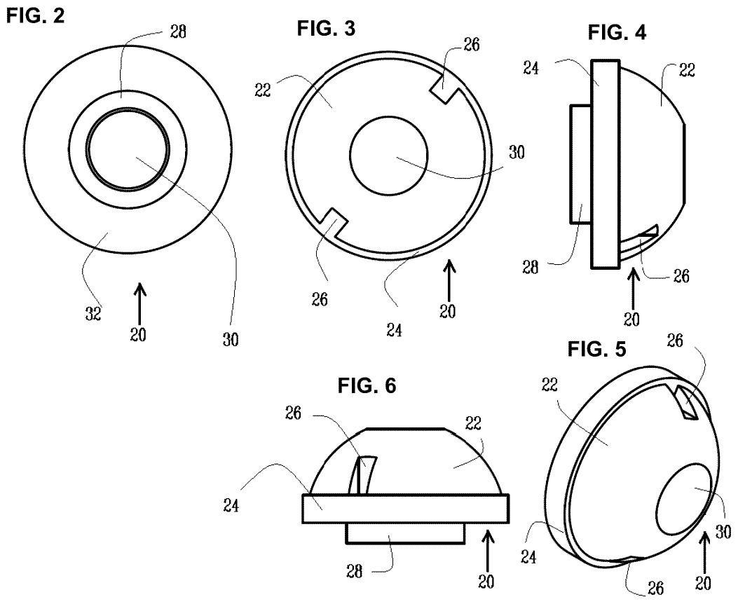

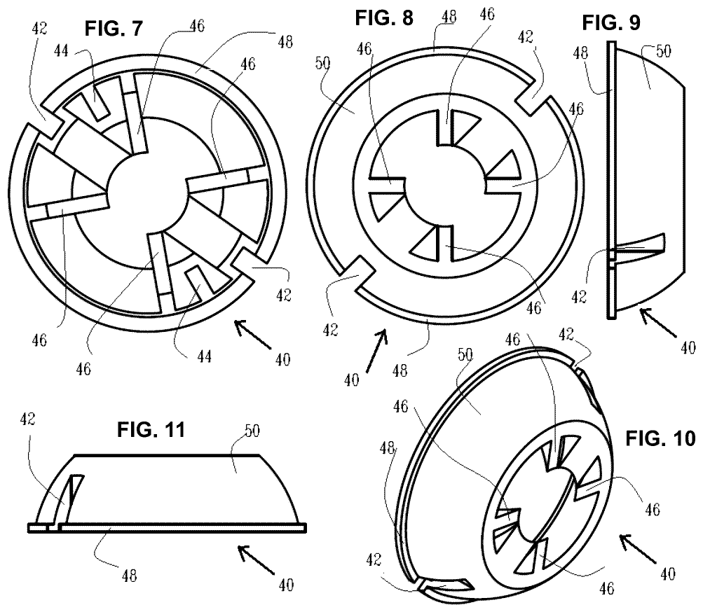

The present disclosure provides the expandable jam chuck 10, whose size and/or geometric profile may be adapted/expanded based on the requirements (i.e., the internal surface profile of the workpiece 13). The expandable jam chuck 10 may act as a form or support around which the workpiece 13 can be shaped, crafted, refined, or machined. In one or more embodiments of the present disclosure, the expandable jam chuck 10 may be specifically designed to engage an internal surface of the workpiece 13 and provide a secure hold during rotational operations. The expandable jam chuck 10 may be configured to accommodate workpieces of varying internal diameters and surface profiles, thereby providing versatility. The expandable jam chuck 10 may include a base jam chuck (such as base jam chuck 20 shown in FIGS. 2 to 6) which may be attached to the chuck 12 of the lathe machine 11. To adapt the expandable jam chuck 10 to different internal geometric profiles of the workpiece 13, one or more expansion jam chucks (such as expansion jam chucks 40 shown in FIGS. 7 to 19) may be configured to interlock with each other in a nested arrangement over the base jam chuck 20 (i.e., by interlocking with an intermediate jam chuck, which in-turn is configured to mechanically interlock with the base jam chuck 20). The number and types of expansion jam chucks 40 may be selected such that the geometric profile of the assembled expandable jam chuck 10 complements that of the internal surface profile of the workpiece 13.

For the sake of brevity and clarity, other conventional components of the lathe machine 11, which do not directly pertain to the subject matter of the present disclosure, are not described in detail herein. However, it should be understood that the lathe machine 11 may incorporate additional elements commonly known in the art to facilitate standard woodworking operations.

Referring now to FIGS. 1B and 1C, a longitudinal cross-section view of an exemplary assembly for woodworking is illustrated, and an exemplary representation of the workpiece held by the expandable jam chuck and the tail stock is illustrated, respectively, in accordance with one or more embodiments of the present disclosure. As shown, (wooden) workpiece 13 may have a concave end opening 13A (may also be referred to as cavity 13A), defined by an internal surface 13B. The internal surface 13B may have a substantially circular cross-section, and may have a conical or other alternative geometrical profile, but not limited thereto.

The workpiece 13 may be abutted against the expandable jam chuck 10 by a tail stock 14. As stated, the expandable jam chuck 10 may include a base jam chuck 20 and one or more of the expansion jam chucks 40. The base jam chuck 20 may include, at one end of a portion of the base jam chuck 20, a peripheral lip 24 and a holding end/tenon 28. The portion may be formed with a base outer surface 22.

The expansion jam chuck 40 may be shaped and configured to at least partially envelop or fit around the portion. Further, the ribs 44 and the channels 26 (as shown in FIGS. 3-11), or other equivalent interlocking means, may be provided at the expansion jam chuck 40 and the base jam chuck 20, to mechanically couple the expansion jam chuck 40 with the base jam chuck 20 and to prevent any relative rotational movement between the two components.

The expansion jam chuck 40 may have an expansion outer surface 50 which may be shaped, sized, and dimensioned to extend at least partially into the cavity 13A, thereby establishing a frictional engagement between the internal surface 13B of the workpiece 13 and the expandable jam chuck 10 to prevent rotation between the respective base jam chuck 20 and the expansion jam chuck 40.

The holding end/tenon 28 may be configured to interface/couple with either the chuck 12 of a lathe 11 (as shown in FIG. 1A) or the main threaded shaft 16 of the lathe 11 (as shown in FIG. 1D), thereby selectively imparting rotational motion to the workpiece 13. In the embodiment shown in FIG. 1A, the chuck 12 may be attached to the threaded shaft 16 through a threaded arrangement. In the embodiment shown in FIG. 1D, the expandable jam chuck 10 (i.e., through the base jam chuck 20) may be directly attached to the threaded shaft 16, via a threaded connection therebetween. In such embodiments, the base jam chuck 20 may be hollow, with threads defined on an internal surface thereof, that completement the threads of the threaded shaft 16. In some embodiments, the base jam chuck 20 may include a base jam chuck end configured for securing the base jam chuck to the lathe 11. The base jam chuck end may be coupled to the chuck 12, or the threaded shaft 16. In the illustrated arrangement, the opposite end of the workpiece 13 may be rotatably supported by the tailstock 14.

Further, during operation, the workpiece 13 may be positioned between the tailstock 14 and the threaded shaft 16 (through the expandable jam chuck 10). In some embodiments, the tailstock 14 may be advanced toward the threaded shaft 16 to compress the workpiece 13 between the expandable jam chuck 10 and/or the threaded shaft 16. As the tailstock 14 abuts and compresses the workpiece 13, the expansion outer surface 50 of the expansion jam chuck 10 may come into contact with a corresponding portion of the internal surface 13A, which may produce a strong frictional engagement between the workpiece 13 and the expandable jam chuck 10 (as shown in FIGS. 1A to 1D), ensuring that, upon activation of the motor 15 of the lathe 11 (as shown in FIGS. 1A to 1D) to drive rotational motion, the workpiece 13 may be securely spun (through the expansion jam chuck 10) without slippage relative to the expandable jam chuck 10. Hence, the abutment may cause the workpiece 13 to be rotationally locked with the threaded shaft 16 through the expandable jam chuck 10.

In some embodiments, the number, size, and shapes of the expansion jam chucks 40 mounted over the base jam chuck 20 may be selected based on geometric profile (including the size and the shape) of the internal surface 13A. For workpieces 13 having a relatively smaller internal surface 13A, the expansion jam chuck 40 may be omitted and the base jam chuck 20 alone may be utilized to establish the requisite frictional engagement via the base outer surface 22. For workpieces 13 having a relatively larger internal surface 13A, the expansion jam chuck 40 may be mounted over the base jam chuck 20 to establish the requisite frictional engagement via its outer surface 22. Further, those expansion jam chucks 40 may be selected that correspond to or complete the geometric profile of the internal surface 13A.

Referring to FIGS. 2-6, a base jam chuck 20 of the expandable jam chuck 10 is illustrated, in accordance with one or more embodiments of the present disclosure. FIGS. 2 and 3 show a bottom view and a top view of the base jam chuck 20, respectively. FIGS. 4 and 6 provide side views, and FIG. 5 provides a perspective view of base jam chuck 20. The base jam chuck 20 may include a holding end 28 formed at a bottom section/surface 32 (may also be referred as tenon), around a center 30 thereof. In some embodiments, the base jam chuck 20 may be substantially hollow, for saving/minimizing material (and thereby saving cost). In other embodiments, the base jam chuck 20 may be solid. The hollow-ness or solid-ness of the base jam chuck 20 may be suitably selected as a trade off between cost (i.e., with respect to material required to manufacture), and rigidity of the base jam chuck 20. In some embodiments, the base jam chuck 20 may have a substantially hemispherical profile or a frusto-hemispherical profile, having a substantially cylindrical hollow portion therein. In some embodiments, the base jam chuck 20 may include a threaded surface configured to engage with corresponding threads defined on the shaft 16, thereby allowing the base jam chuck 20 (and the expandable jam chuck 10) to be rotationally locked with the shaft 16.

In some embodiments, the hollow portion may be at least one of, a tenon, a shoulder, or a provision (but not limited thereto), configured to enable mechanical connection of the base jam chuck 20 with the lathe chuck 12 and/or a headstock of the lathe machine 11. In some embodiments, a mortise extending from the lathe chuck 12 may be configured to fit into/mechanically couple with the hollow portion of the base jam chuck 20, such that the base jam chuck 20 and the lathe chuck 12 are mechanically locked (and thereby also rotationally locked). In some embodiments, the mortise and the hollow portion may be threaded, the threaded connections being configured to provide a secure connection between the base jam chuck 20 and the threaded shaft 16 of the lathe 11, eliminating in this case the need to use a chuck. In further embodiments, other reversible attachment means (such as adhesives, interlocking structures, and the like) may be used to mechanically interlock the base jam chuck 20 with the lathe chuck 12.

In some embodiments, the holding end 28 (tenon) may extend outwards from the bottom section 32 of the base jam chuck 20. The holding end 28 (tenon) may be grabbed by the lathe chuck 12, for mechanical interlocking. In some embodiments, the holding end 28 may be configured to interference fit into a provision on the lathe chuck 12 for mechanical interlocking. In other embodiments, the lathe chuck 12 may include other elements (such as interlocking elements, or threaded grabbers that extend and hold the base jam chuck 20 therebetween) for physically holding the base jam chuck 20 by the holding end 28. In some embodiments, the mortise may be configured to engage with an inner surface of the holding end 28, for holding the base jam chuck 20. In some embodiments, either holding end 28, or the hollow portion, or a combination thereof, may be used to secure the base jam chuck 20 with the lathe chuck 12.

In some embodiments, the base jam chuck 20 may include one or more channels 26 formed on the base outer surface 22 (also referred to as top surface 22). The channels 26 may be formed as indents or cavities on the top surface 22. The channels 26 may be configured to receive one or more interlocking ribs (such as interlocking ribs 44 of the expansion jam chucks 40, as shown in FIG. 7). The channels 26 may be configured to have a complementary geometric profile to that of the interlocking ribs 44. While two channels 26 are shown in FIG. 3, it may be appreciated that the base jam chuck 20 may be configured to have any number of channels 26 defined on the top surface 22 thereof, corresponding to the number of the interlocking ribs 44 on the expansion jam chucks 40. In some embodiments, the channels 26 may be equidistant from each other.

In some embodiment, the base jam chuck 20 may include the peripheral lip 24 formed on the perimeter of the bottom section/surface 32. The lip 24 may be a projection/extrusion that extends from the perimeter of the bottom section/surface 32. The lip 24 may be configured to prevent the expansion jam chuck 40 (or the intermediate jam chuck) from rolling off the top surface 22 of the base jam chuck 20, when the expansion jam chuck 40 is interlocked thereto. The lip 24 may ensure that the expansion jam chuck 40 is aligned over the base jam chuck 20, by allowing seating a rim/bottom edge of the expansion jam chuck 40 over the lip 24.

Referring to FIGS. 7-11, different views of the expansion jam chuck 40 are illustrated, in accordance with one or more embodiments of the present disclosure. FIG. 7 shows a bottom view of the expansion jam chuck 40, while FIG. 8 shows a top view of the expansion jam chuck 40. Further, FIG. 9 illustrates a vertically positioned side view, and FIG. 11 illustrates a horizontal positioned side view of the expansion jam chuck 40. FIG. 10 illustrates a perspective view of the expansion jam chuck 40.

As stated, one or multiple ones of the expansion jam chuck 40 may be interlocked in a nested arrangement over the base jam chuck 20. The expansion jam chucks 40 chosen for interlocking in the nested arrangement may be selected to complement the internal surface profile of the workpiece 13. In some embodiments, the expansion jam chuck 40 may be interlocked over the base jam chuck 20, and/or other expansion jam chucks 40. Further, the expansion jam chuck 40 may also include one or more channels 42 formed at an edge, extended partially or thoroughly toward the expansion outer surface (also referred to as top section/surface 50) of the expansion jam chuck 40. The channels 42 may be configured to receive interlocking ribs 44 of the other expansion jam chucks 40, to allow multiple ones of the expansion jam chucks 40 to be assembled in a nested arrangement over the base jam chuck 20.

The expansion jam chuck 40 configured to interlock with the base jam chuck 20 may be hereafter referred to as ‘intermediate expansion jam chuck,’ and the expansion jam chucks that are configured to interlock over other ones of the expansion jam chuck 40 may be referred to as ‘other expansion jam chucks,’ hereafter.

In some embodiments, the intermediate expansion jam chucks may include one or more interlocking ribs 44 configured to fit into the channels 26 of the base jam chuck 20. In some embodiments, the interlocking ribs of the other expansion jam chucks 40 may be configured to fit into the channels 42 of the intermediate expansion jam chucks, or ‘preceding’ expansion jam chucks (also referred to as ‘another’ successive jam chuck), as described subsequently in the present disclosure. The interlocking ribs 44 may be defined on an inner side or inner surface of the expansion jam chucks 40. The interlocking ribs 44 may be defined as extrusions/protrusions extending from the inner surface of the expansion jam chucks 40. In some embodiments, the geometric profile of the expansion jam chucks 40 may complement that of the channels (26 or 42).

In some embodiments, the expansion jam chucks 40 may include one or more supporting ribs 46 formed on an inner side or an inner surface of the expansion jam chuck. In one or more embodiments, the supporting ribs 46 may be defined to form gussets, bosses, corrugations, honeycomb patterns, and the like, but not limited thereto. In one embodiment, the supporting ribs 46 may include one or more protrusions defined on an interior surface thereof. The supporting ribs 46 may be configured/designed to provide rigidity to (i.e., increase structural integrity of) the expansion jam chuck 40. Further, the supporting ribs 46 may be configured to rest on the top section 22 of the base jam chuck 20 and provide support for the top section/surface 50 of the expansion jam chuck 40. The support ribs 46 may prevent bending and/or deformation of the expansion jam chuck 40 under pressure during the turning process. In some embodiments, the supporting ribs 46 may be configured to enhance friction between two expansion jam chucks 40, or the intermediate and other expansion jam chucks 40, to prevent sliding therebetween. Further, the supporting ribs 46 may allow the thickness of the expansion jam chuck 40 to be lowered, while retaining the rigidity thereof.

Further, the expansion jam chuck 40 may also include a lip 48 formed on a perimeter of a bottom section of the expansion jam chuck 40. The lip 48 may be designed (structurally and functionally) similarly to the lip 24 of the base jam chuck 20. The lip 48 may be configured to stop and/or prevent any of (successive) expansion jam chucks 40 from rolling to the side of a preceding expansion jam chuck (or the another successive jam chuck mounted over the expansion jam chuck), and keeping all used expansion jam chucks 40 aligned.

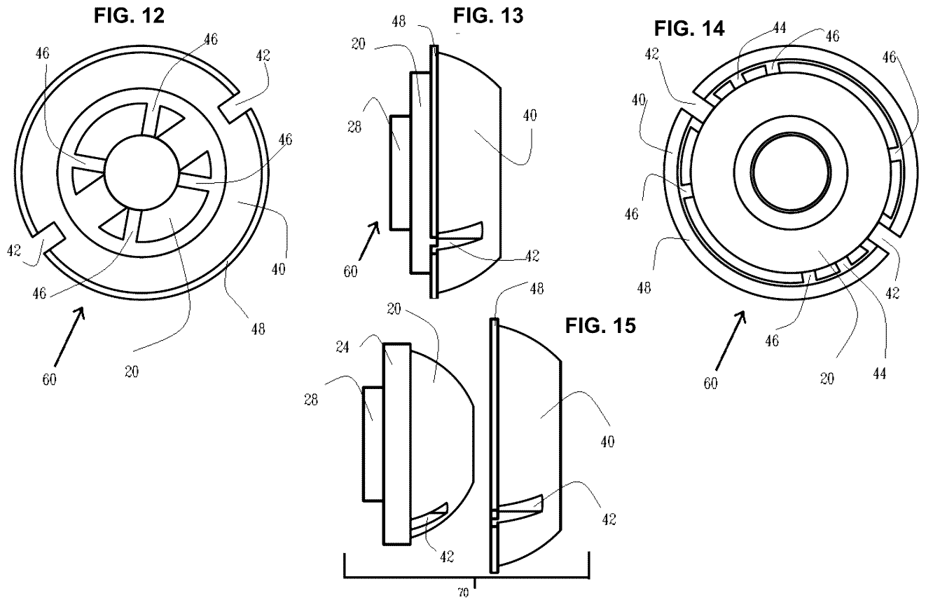

Referring to FIGS. 12-15, different views of another expandable jam chuck 60 having an intermediate expansion jam chuck connected to the base jam chuck 20 are illustrated, in accordance with one or more embodiments of the present disclosure. A top view and a bottom view of the intermediate expansion jam chuck interlocked with the base jam chuck 20, are shown in FIGS. 12 and 14, respectively. FIG. 13 shows an assembled view, and FIG. 15 shows an exploded/disassembled view of the intermediate jam chuck and the base jam chuck 20.

In some embodiments, the interlocking ribs 44 of the (intermediate) expansion jam chuck 40 may be configured to fit into (or mechanically couple with) a corresponding matching channel of/from the channels 26 of the base jam chuck 20. The intermediate expansion jam chuck 40 may be connected to the base jam chuck 20 when the diameter of the workpiece 13 is greater than that of the base jam chuck 20. The intermediate expansion jam chuck 40 may provide the additional diameter to the base jam chuck 20 required for securing the workpiece 13 against the tailstock 14. Further, the intermediate expansion jam chuck 40 may allow the other expansion jam chucks to be connected over the intermediate expansion jam chuck 40, as shown in FIGS. 16-19.

Referring to FIGS. 16-19, another expandable jam chuck 80 and an expandable jam chuck kit 90 are illustrated, in accordance with one or more embodiments of the present disclosure. FIGS. 16 to 18 illustrates a top view, a vertical side view and a bottom view respectively, of the expandable jam chuck 80. FIG. 19 illustrates a disassembled/exploded view of the expandable jam chuck 80.

In some embodiments, in addition to the intermediate expansion jam chuck interlocked with the base jam chuck 20, the expandable jam chuck 80 may include other expansion jam chucks 40 interlocked over the intermediate expansion jam chuck in a nested arrangement. The intermediate expansion jam chuck 40 is labelled as ‘40A’ (may also be referred to as the smallest or first of the one or more expansion jam chuck 40) and other expansion jam chucks are labelled 40B-40D (which are also referred to as successive expansion jam chucks). In some embodiments, a diameter of each successive expansion jam chuck (such as expansion jam chuck 40B with respect to the intermediate jam chuck 40A, or expansion jam chuck 40C with respect to the expansion jam chuck 40B) may have a diameter greater than that of a preceding jam chuck (such as the intermediate expansion jam chuck 40A in the case of expansion jam chuck 40B). Here, “successive” may refer to an expansion jam chuck that may be fit immediately over another expansion jam chuck, and “preceding” may refer to the expansion jam chuck (or another successive expansion jam chuck mounted over the expansion jam chuck) that may be under another expansion jam chuck. The successive expansion jam chuck may be configured to mount over the expansion jam chuck (such as expansion jam chuck 40) and/or another successive jam chuck (such as 40B with respect to 40C) mounted over the expansion jam chuck (e.g., 40).

As shown, the interlocking ribs 44 of the intermediate expansion jam chuck 40A may be configured to fit into corresponding matching channel from the channels 26 of the base jam chuck 20. Further, one or more interlocking ribs defined on an expansion inner surface of the successive expansion jam chuck may be configured to mechanically couple with one or more corresponding channels defined on the expansion outer surface 50 or an outer surface of the another successive expansion jam chuck. The interlocking ribs 44 of each successive expansion jam chuck (such as 40B) may be configured to fit into/mechanical couple with a corresponding matching channel from the channels 42 of the preceding expansion jam chuck (e.g., 40A with respect to 40B) to form the nested arrangement over the intermediate expansion jam chuck 40. The intermediate expansion jam chuck 40A may be the preceding expansion jam chuck to at least one of the successive expansion jam chucks.

The expansion jam chucks 40 may be adapted to have any geometric profile, based on requirements and/or constraints of the use case (i.e., the internal surface profile of the workpiece 13).

In some embodiments, the base jam chuck 20 and the one or more expansion jam chucks 40 may be assembled to form a ‘first-type’ expandable jam chuck, which may have a geometric profile indicative of, but not limited to, any one or a combination of: a substantially frusto-hemispherical profile, a substantially frusto-conical profile, a substantially frusto-hemiovoidal profile, a substantially frusto-prismatic profile, an irregular profile, or a substantially frusto-oval or frusto-ovoidal profile. The ‘frusto’ or frustrum shape of the expandable jam chuck kit may save material (since less material may be used in comparison to having hemispherical profiles, for example). Further, the expandable jam chuck kit may be able to securely hold the workpiece 13 (through force of friction), without requiring the expandable jam chuck kit to be in contact with the entire internal surface profile of the workpiece 13. In some non-limiting examples, the diameter of the expansion jam chucks 40 of the first-type expandable jam chuck kit may be between about 8.6 cm to about 18 cm. In such examples, the base jam chuck 20 may have a diameter of 8.6 cm or lower.

In some embodiments, each of the base jam chuck 20 and the expansion jam chucks 40 (or a ‘second-type’ expandable jam chuck kits) may be defined to have a geometric profile indicative of any one or a combination of, a hemispherical profile, a conical profile, a cylindrical profile, an oval profile, or an irregular profile, but not limited thereto, when assembled, as shown in FIG. 19. As stated, the base jam chuck 20 may be hollow or solid. In some embodiments, the expansion jam chucks 40 may have inner surfaces thereof defined to complement the top surface 22 of the base jam chuck 20, and/or other expansion jam chucks. On being assembled, the second-type expandable jam chuck kit may have any of the aforementioned geometric profiles. In some non-limiting examples, the diameter of the expansion jam chucks 40 of the second-type expandable jam chuck kit may be between about 2.3 cm to about 6.2 cm. In such examples, the base jam chuck 20 may have a diameter of 2.3 cm or lower. However, it may be appreciated that the dimensions described above are non-limiting examples, and those skilled in the art may suitably adapt the expandable jam chuck kits to have other diameters as well.

Since the second-type expandable jam chuck kits may have smaller dimensions in comparison to the first-type expandable jam chuck kits, additional provisions may be defined on the expansion jam chucks 40 and/or the base jam chuck 20 for convenient disassembly. In some embodiments, each of the expansion jam chucks 40 may include one or more recesses configured to enable the successive/succeeding expansion jam chucks 40 to be removed from the base jam chuck 20 and/or preceding expansion jam chucks 40, when a levered element is pushed thereinto. The levered element may assist to separate the one or more interlocking ribs 44 from the channels (26 or 42), and accordingly separate the one or more expansion jam chucks 40. In some embodiments, the levered element may be a screw/screw head, and/or other elongated structures configured to fit into the recess, and provide leverage to separate the interlocking ribs 40 from the channels (26 or 42).

In some embodiments, a cloth material may be disposed between each of the expansion jam chucks 40, and/or the base jam chuck 20 and the expansion jam chucks 40, to prevent sliding therebetween. In place of the cloth material, other materials such as, but not limited to, rubber sheets, foam pads, silicone liners, or textured polymer films may also be utilized to achieve similar anti-sliding effects. Such materials may provide varying degrees of friction, flexibility, and cushioning to accommodate different operational requirements and workpiece materials. Selection of an appropriate alternative materials may depend on factors such as the desired grip strength, durability, and compatibility with the workpiece 13 between the surfaces of the expansion jam chucks 40. Alternatively, the top sections/surfaces (22, 50) and inner surface of the expansion jam chucks 40 may have textured surfaces to increase friction therebetween, for preventing sliding. In some embodiments, the textured surface may be formed by multiple nipples or protrusions defined on the top sections/surfaces (22, 50) and inner surface of the expansion jam chucks 40.

In some embodiments, the base jam chuck 20 and the expansion jam chucks 40 may be made of any one or a combination of, plastics, or metals, but not limited thereto. For instance, other materials such as composite materials, or reinforced polymers may be utilized to achieve desired mechanical properties, including strength, durability, and resistance to wear and tear. In some embodiments, the base jam chuck 20 and the expansion jam chucks 40 may be manufactured using three-dimensional printing, injection molding, computer numerical control machining, and the like, but not limited thereto.

In some embodiments, expandable jam chuck kits 70, 80, 90 (as shown in FIGS. 15 to 19) may include a base jam chuck 20 configured to mechanically connect with a chuck 12 of a lathe 11 or mounted directly onto the threaded shaft of the lathe. The expandable jam chuck kit 90 may also include one expansion jam chuck 40, or multiple expansion jam chucks 40A-40D (or more). Each of the one or more expansion jam chucks 40 may be selectively interlocked in the nested arrangement based on an internal surface profile and size of the workpiece 13. The size of the project/workpiece 13, the inner curve and diameter of the workpiece 13 to work on determine which expansion jam chucks 40, and the number of expansion jam chucks to use. The larger the diameter of the workpiece 13, the larger or greater number of expansion jam chucks 40 may be used. Each expansion jam chuck 40 may be supported by a smaller (preceding) expansion jam chuck 40 or mandrel, up to the base jam chuck 20 that gets inserted and held by the lathe chuck 12 or mounted directly onto the threaded shaft of the lathe-of the lathe machine 11. The expandable jam chuck (kits) may be assembled, and used to jam the workpiece 13 against the tailstock, to rotationally lock either the lathe chuck 12 or shaft 16 to the workpiece 13, the lathe chuck 12 or shaft 16 in-turn being driven by the lathe motor assembly 15 for woodturning. Having multi-sizes of expansion jam chucks 40 allows the woodturner to have one tool to accommodate multiple projects/workpieces 13 with different sizes. The structure of the expandable jam chuck (kits) also allows the woodturners to get access all the way to the beginning of the external peripheral of the workpiece 13 under the process.

Hence, the present disclosure provides an expandable jam chuck with an ability to securely hold a wide range of workpiece sizes and shapes, enhancing versatility in woodturning projects. The expandable jam chuck may be expanded or retracted by attaching and/or removing, respectively, expansion jam chucks to adjust size/diameters, radius of curvature and/or geometric profiles of the expandable jam chuck. Assembling the expansion jam chucks in nested arrangement of expansion jam chucks allows for easy adjustment and customization based on the workpiece requirements. Further, the expandable jam chuck may be compatible with existing lathe equipment. Additionally, the present disclosure provides an expandable jam chuck that is cheaper and simpler to manufacture, and assemble.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

I/we claim:

1. An expandable jam chuck mounting a wooden workpiece on a lathe, the wooden workpiece having a concave end opening defined by an internal surface, said expandable jam chuck comprising:
a base jam chuck having a base jam chuck end configured for securing said base jam chuck to the lathe, and a portion formed with a base outer surface; and
an expansion jam chuck having an interlocking member coupling the expansion jam chuck to the base jam chuck and having an expansion outer surface;
wherein one of: the base outer surface and the expansion outer surface are shaped and sized to form a frictional engagement with the internal surface of the wooden workpiece to prevent rotation between the respective base jam chuck and the expansion jam chuck.

2. The expandable jam chuck of claim 1 wherein the lathe comprises a motor and the base jam chuck end is coupled to the motor to rotate the wooden workpiece.

3. The expandable jam chuck of claim 1 wherein the lathe has a chuck and the base jam chuck end is coupled to the chuck.

4. The expandable jam chuck of claim 1, wherein the lathe has a main threaded shaft and the base jam chuck end is coupled to the main threaded shaft.

5. The expandable jam chuck of claim 1, wherein the base jam chuck comprises at least one of: a tenon, a shoulder, or a provision, configured to mechanically connect the base jam chuck with a chuck of the lathe and/or a headstock of the lathe and/or the base jam chuck with a main threaded shaft of the lathe.

6. The expandable jam chuck of claim 1, wherein the interlocking member comprises one or more channels on the base outer surface, the one or more channels being configured to mechanically couple with one or more interlocking ribs on an expansion inner surface of the expansion jam chuck.

7. The expandable jam chuck of claim 1, further comprising a successive expansion jam chuck configured to mount over the expansion jam chuck and/or another successive jam chuck mounted over the expansion jam chuck.

8. The expandable jam chuck of claim 7, wherein a diameter of the successive jam chuck is greater than that of the expansion jam chuck and/or the another successive expansion jam chuck.

9. The expandable jam chuck of claim 6, wherein one or more interlocking ribs defined on an expansion inner surface of the successive expansion jam chuck are configured to mechanically couple with one or more channels defined on the expansion outer surface or an outer surface of the another successive expansion jam chuck.

10. The expandable jam chuck of claim 1, wherein the expansion jam chucks comprise a recess configured to enable the expansion jam chucks to be removed from the base jam chuck when a levered element is pushed into the recess to separate the one or more interlocking ribs from the one or more channels.

11. The expandable jam chuck of claim 1, wherein the base jam chuck and the expansion jam chuck comprises materials made of any one or a combination of: plastics, and metals.

12. The expandable jam chuck of claim 1, wherein the base jam chuck and the expansion jam chuck are made of different materials.

13. The expandable jam chuck of claim 1, wherein the expansion jam chuck and/or one or more successive jam chucks mounted over the expansion jam chuck comprise a supporting rib defined on an inner surface thereof, wherein the supporting rib is configured to increase rigidity of the expansion jam chucks, and the rigidity of the expandable jam chuck.

14. The expandable jam chuck of claim 1, wherein a cloth material is disposed between the expansion jam chuck and the base jam chuck, and/or between the expansion jam chuck and one or more successive expansion jam chucks mounted over the expansion jam chuck to prevent sliding therebetween.

15. The expandable jam chuck of claim 1, wherein the workpiece is secured between the expandable jam chuck and a tailstock of the lathe.

16. An expandable jam chuck, comprising:
a base jam chuck configured to mechanically connect with a chuck of a lathe or mounted directly onto a threaded shaft of the lathe; and
one or more expansion jam chucks, wherein an intermediate expansion jam chuck from the one or more expansion jam chucks is configured to interlock with the base jam chuck, and other expansion jam chucks from the one or more expansion jam chucks are configured to interlock in a nested arrangement over the intermediate expansion jam chuck,
wherein each of the one or more expansion jam chucks is selectively interlocked in the nested arrangement based on an internal surface profile and size of a workpiece.

17. The expandable jam chuck kit of claim 16, wherein the base jam chuck and the one or more expansion jam chucks are assembled to form an expandable jam chuck, which has a geometric profile indicative of any one or a combination of: a hemispherical profile, a conical profile, a cylindrical profile, an oval profile, or an irregular profile, and wherein the one or more expansion jam chucks comprise one or more recesses to facilitate disassembly.

18. The expandable jam chuck kit of claim 16, wherein the base jam chuck and the one or more expansion jam chucks are assembled to form an expandable jam chuck, which has a geometric profile indicative of any one or a combination of: a substantially frusto-hemispherical profile, a substantially frusto-conical profile, a substantially frusto-hemiovoidal profile, a substantially frusto-prismatic profile, an irregular profile, or a substantially frusto-oval profile.

19. The expandable jam chuck kit of claim 16, wherein the base jam chuck and/or the one or more expansion jam chucks comprise lips on an outer and bottom side of the base jam chuck and/or the other expansion jam chucks thereof for assembly, to stop and prevent any of the one or more expansion jam chucks from rolling to the side, and keeping all used expansion jam chucks aligned vertically.

20. The expandable jam chuck kit of claim 16, wherein a geometric profile of an expandable jam chuck formed by the base jam chuck, or the base jam chuck and the one or more expansion jam chucks partially or entirely complements the internal surface profile of the workpiece.
